(19) United States
(12) Patent Application Publication
(10) Pub. No.: US 2005/0288961 A1
(43) Pub. Date: Dec. 29, 2005

(54) Method for a server-less office architecture

(75) Inventor: Majid Tabrizi, Herndon, VA (US)

Correspondence Address: STEVENS DAVIS MILLER & MOSHER, LLP, 1615 L STREET, NW, SUITE 850, WASHINGTON, DC, 20036, US

(73) Assignee: ePlus Capital, Inc., Herndon, VA (US)

(21) Appl. No.: 11/167,606

(22) Filed: Jun. 28, 2005

Related U.S. Application Data
(60) Provisional application No. 60/582,802, filed on Jun. 28, 2004.

(51) Int. Cl. G06F 17/60

(52) U.S. Cl. 705/1

(57) ABSTRACT

A way is provided for architecting a server-less office that delivers anywhere anytime computing support to an organization. The server-less office comprises a plurality of information technology IT components selected based on business objectives and constraints associated with the business function of the organization to work together to deliver computing support functions to a plurality of end users who no longer have local computing support and may only have thin clients on their desks. A pre-determined server-less architecture is imposed by the present invention by including at least four architectural groupings of IT components that the organization must map the objectives and constraints of its business functions onto for IT component selection purposes. A local group is included in this minimum set of groups so that unique processing needs can be satisfied that are not met by the imposed pre-determined server-less office architectural groupings.

### REFERENCE TO RELATED APPLICATION

This application claims the benefit of U.S. provisional application Ser. No. 60/582,802, filed Jun. 28, 2004, the entire disclosure of which is herein incorporated by reference

### BACKGROUND OF THE INVENTION

1. Field of the Invention

The present invention relates to a method for defining a server-less office architecture that meets pre-determined business objectives and business constraints by providing users thereof anywhere anytime access to appropriate IT resources.

2. Description of the Related Art

Twenty-fine years ago the Information Technology (IT) industry could be characterized as follows; there was no personal computing; mainframes were king; processing and storage were expensive; software was developed in-house or available from a few vendors; and user access was limited and tightly controlled.

Five years ago the landscape was changing: personal computers were ubiquitous and a common organizational goal was to put a PC on every desktop; processing and storage was cheap and fast; software was available from thousands of providers; viruses, worms, spy-ware, and network intrusion were starting to become pervasive; data storage requirements were increasing geometrically; and the industry was experiencing rapid obsolescence of hardware and software.

More recently, there are multiple servers in every office; n-tier architectures include database servers, web servers, and application servers; help desks (i.e., places a user can visit or call to get assistance with a wide range of IT related problems related to hardware, software, communications, networks, application usage, etc.) support hundreds of desktop users; non-standard configurations require support personnel and users to constantly increase their skill sets; maintenance of incompatible configurations increase IT support workloads; software license violations are increasing; firewalls, cookies, junk mail are proliferating; security has become IT's number one priority; and it appears that the increase in IT worker productivity is slowing down. And, as a result, departmental fiefdoms often have emerged, characterized by counterproductive political and budgetary infighting to gain the leverage to implement independent architectures to meet individualized group needs without first considering the overall needs of the organization.

### SUMMARY OF THE INVENTION

Throughout the following disclosure the names of several third party products appear. These third party products are included as examples only, and each is intended to represent a class of functionality that can be provided by the method of the present invention, using at least one of a proprietary product and a third party product.

The present invention, a server-less office, utilizes an iterative, customized methodology, which, in response to pre-determined performance improvement and cost reduction business drivers identifies, evaluates and integrates into a server-less office a plurality of IT components that an organization can provide to its staff in order to improve the management of their information resources.

Within an organization, the following staff members can benefit from the server-less office of the present invention:
end users;
help desk personnel;
IT software specialists;
IT hardware specialists; and
IT managers;
   The benefits that an organization can realize by implementing a server-less office according to the present invention, include:
improved security from virtual private networks (VPNs), Firewalls, DMZs where DMZ=demilitarized zone, a computer or small sub network that sits between a trusted internal network such as a corporate private local area network (LAN), and an untrusted external network, such as the public Internet;
improved control over all aspects of asset management thru the asset lifecycle;
improved standards for hardware and software;
improved backup capability;
improved virus and junk mail control;
improved software license control;
improved data storage and retrieval;
improved network performance, scalability and reliability;
reduced costs of network, hardware and software component acquisition, management and total cost of ownership;
reduced costs due to reduced space requirements;
reduced phone costs due to increased use of IP telephony;
reduced or eliminated data redundancy;
improved productivity, and reduced training costs and time, for IT support personnel due to standardization of hardware, software and implementation procedures;
improved business continuity from improved fail over, controlled data redundancy, reduced single points of failure, improved data throughput, reduced system downtime, improved backup functionality and increased disaster recovery functionality;
improved collaboration between geographically disperse project personnel;
reduced travel expenses due to improved communication such as video conferencing and internal Web-based conferencing;
reduced hardware costs due to shared components;
improved bandwidth and processing speeds due to storage area network (SAN) components;
increased flexibility to respond efficiently and effectively to rapidly changing business requirements;
reduced risk of system outages and data loss from controlled redundancy of shared system components; and
improved virus detection and control due to relay devices and procedures.

The method of the present invention provides an architecture for a server-less office that includes a collection of IT components that are selected, tested and integrated to work together in a pre-defined manner to address pre-determined business needs. The business objectives that can be addressed by the present invention include:
provide multi-location multi-session computing anywhere anytime;
reduce capital investment and IT operating costs;
control access and content simply and centrally;
maximize continuity of service and uptime;
provide storage and retrieval of data regardless of its source and its type;
provide secure data, data storage, and data transfer; and
provide management of applications, their licenses, and any compliance requirements.

The server-less office of the present invention balances the need to centralize and standardize cost-effective services, while still providing flexible, individualized support and customized applications to a wide range of IT users.

The decision to implement a server-less office has important strategic and tactical implications. Departmental fiefdoms and budgetary powers will be modified, previous project authority will be reassigned, selected functions and services will be centralized, support and development resources will be reassigned, priorities will be assigned globally rather than remotely, and many users will be required to use standard equipment. The decision to implement a server-less office imposes a centralized IT framework within which an organization's business objectives and business constraints are satisfied. This framework identifies the elements that will shape the overall architecture. These elements are drawn, in part, from the business objectives and constraints, and in part from the internal requirements imposed by the implementation requirements of a server-less office. The framework elements include business objective and business constraints that reflect organizational structure; budgetary and resource authority; centralized administration; centralization of computing, storage, backup, disaster recovery and security; hardware and software standardization; redundancy to avoid single points of failure; interdependent vs. independent prioritization; as well as other elements that are unique to the organization. The framework provides the global criteria for the selection of candidate IT components that represent the entire organization's objectives and constraints with regard to anywhere anytime computing support and which drives the selection of candidate IT components for a server-less office architecture. The framework is an imposed architecture for centralized computing support and it is provided by the present invention after it has been particularized by an analysis of the business objectives and business constraints of an organization seeking to achieve anywhere anytime computing support rather than its existing support structure.

The present invention imposes generic business constraints, including the following:
remove all computing related components from the user level;
centralize all computing, security, administration and storage;
connect the users to the centralized IT resources; and
create redundancies to avoid single points of failure.

By taking this approach, the server-less office of the present invention is distinguishable from the typical IT consolidation effort in which:
not all computing related components are removed from the user's location;
the environment is not scalable and return on investment (ROI) diminishes as the IT environment grows;
redundancies are cost prohibitive due to the environment; and
the computing support provided is not totally controllable due to the incompatibilities of its various components.

The present invention comprises a set of steps wherein the generic business objectives and business constraints of a server-less office are first particularized to an individual organization by doing a requirements analysis and defining at least one global IT process in terms of global business objective and business constraints for centralized anywhere anytime computer support. Once these global business objective and business constraints have been identified, IT processes are identified that address local requirements in terms of local business objectives and business constraints. Then given these IT processes, selection and performance criteria are developed and candidate IT components are rated and ranked for satisfaction of the sections criterion and then tested in combination with other components to create a server-less office. If any integration problems occur for a candidate IT component that cannot be resolved, an available alternative for that IT component is substituted therefore until a best working server-less office architecture results.

A preferred method includes the steps of:
specifying at least one business function to be accomplished at least in part by a server-less office;
   for each specified at least one business function, defining at least one business objective and at least one business constraint that the server-less office must satisfy;
   mapping the at least one business objective and business constraint to at least one candidate IT component selection criteria and at least one candidate IT component performance criteria associated with a plurality of candidate IT components of a pre-determined server-less office architecture thereby;
   ranking each of the plurality of candidate IT components in terms of satisfaction of the mapped selection criteria; and
   selecting a server-less office architecture comprising the best ranked candidate IT components that satisfy the mapped to performance criteria.

The criteria are derived from the business objectives and constraints defined by an organization that must be met by a server-less office architecture.

The criteria are weighted by corresponding weights that define their relative importance to an organization as derived from the business objectives and business constraints defined by the organization.

The candidate IT components are then each scored in terms of how well the components satisfy the weighted criteria.

The component rating for each criterion is multiplied by its corresponding criterion weight and all resulting criteria scores are summed to obtain a total score for the candidate IT component.

The total component satisfaction score (tcss) for a single option=sum of (criterion weight (cw) x criterion satisfaction rating (csr)) for each criterion.

$$tcss = {\sum }_{i = 1}^{n} {cw}_{i} * {csr}_{i}$$

Where n=the number of criterion used to evaluate a candidate IT component

The components within a process having the highest scores are included in a server-less office architecture and are then tested in the architecture. The test results are used to revise the criteria, the criteria weights, and the candidate IT component scores.

The process continues until a ‘best’ architecture for a server-less office is achieved—the best architecture based on the given criteria, weights, ratings and performance testing.

The resulting performance, weights, criteria and score data for each candidate IT component are retained in the criteria database for future reuse.

If a database of candidate IT components and their characteristics is provided that documents prior server-less architectures that include the candidate IT components, then the architecting process can be accomplished more quickly by finding comparable candidate IT components to those being used in a new server-less office and reusing mapping, weightings, and performance measurements stored in the database for the comparable candidate IT components. This is also more cost-effective.

In a preferred embodiment, a server-less office architecture includes the following groupings of IT components integrated into a networked infrastructure that provides a secure, highly available and highly accessible server-less office customized to the objective and constraints of an organization and typically comprising:

GROUPING I—Central Hosting Facility—By taking infrastructure out of existing offices and relocating it to a hosting facility many benefits accrue that would not be cost effective to implement otherwise. These benefits include:
physical security;
power backup for up to 72 hours through generators;
redundant network connections; and
proper ventilation and cooling.
   Typically, a central hosting facility contains all the components of a server-less office architecture in a single location.

While a preferred embodiment of a server-less office is typically accessed by a workstation, desktop or laptop that supports a browser over a network (internal user) or the Internet (internal or external user), it can also be accessed by any other device that is capable of supporting the required communication protocols, such as wireless, handheld, and remote access devices.

In a preferred embodiment, an important object is to eliminate computing and, therefore, data and data management, at the user level. Once the processing no longer takes place at the user level, it is possible to provide a lower (and thus cheaper) processing speed to users without impacting their overall productivity.

Network Infrastructure—In such a centralized hosted environment the performance, scalability, security and availability of an organization's network infrastructure is critical.

Storage Area Network (SAN)

The SAN provides many benefits which can include:
capacity—terabytes;
performance—gigabyte per second (Gbs) Fibre Channel end-to-end. RAID arrays striped across multiple spindles;
reliability and fault tolerance—ability to withstand multiple drive failures;
redundant Fibre Channel switches can provide redundant paths from hosts to storage; and
point-in-time recovery of data through appropriate mirroring strategies.

These features allow an organization to consolidate a plurality of file servers in a single cluster. This can allow an organization to consolidate many clusters with stand-alone, shared storage to one centrally managed storage device. Through the use of such technology as Snapshot and Snapclone the normal backup window is eliminated with regard to any data stored on the SAN. As a result the organization has the ability to create a point-in-time copy of resources on the SAN, and then can back that data up without impacting production data.

Networking—Today networks are the core of many organizations. Critical business functions depend on a fully functioning IT Infrastructure. For many organizations, no network means no ability to generate revenue. The server-less office of the present invention provides an architecture that provides connectivity, bandwidth, Quality of Service, and redundancy that meets or exceeds an organizations business objectives and business constraints.

GROUPING II—Security Facility—In order for the network to support critical business functions the network must be secure. The server-less office of the present invention can provide security that defined by business objectives and business constraints for security, access control and authentication.

Servers & Applications—Servers, including database, web, messaging and application servers, and the software to support them, are the engines that drive today's businesses. The server-less office enables users to design platforms that address all business critical needs from performance and reliability to capacity and scalability.

Storage—the server-less office enables users to implement enterprise backup to protect key data, and to consolidate servers and storage to make more efficient use of management resources. The server-less office enables users to develop a blueprint for a storage infrastructure that puts businesses in control of their storage environment; allowing them to control complexity, uncertainty and risk. With this control, businesses gain efficiency, confidence, effectiveness and—ultimately—business agility.

A preferred embodiment includes a data backup and recovery IT component to create business continuity that includes:
A SAN to provide a centralized data storage;
A new schema is created as follows:
   the data is stored in SAN in real-time;
   the data is replicated to the second SAN in real-time provided that a secondary data center exists. The replication is at BIT level, which makes it platform-neutral;
   an hourly image of the data is also stored to SAN;
   at the end of each day, the data is written to tape, which is stored offsite; and
   the result is that the data exists in duplicate in real-time and is available around the clock every day of the week.

Delivery/Presentation—Operating within the server-less office, users can be more productive because the resources and applications they need are readily available and are presented in a consistent manner. Given today's mobile workforce and non-stop needs, being able to present applications regardless of the user's location, type of connection or hardware platform is necessary to maintain efficiency and productivity.

User Interface—Today's technologies offer several alternatives for user's connection devices. In a preferred embodiment, the server-less office reduces costs and administrative overhead by utilizing thin clients. It is no longer necessary to provide high-power PC's, workstations or laptops for mainstream business applications on the network. Thin clients or terminals provide all the connectivity necessary and reduce costs. Thin clients deployed properly can also enhance security schemes by allowing access only to prescribed resources and preventing users from installing unauthorized applications.

GROUPING III—Communication Facility—A variety of media supported communication are feasible using the infrastructure provided by groupings I and II. This is especially true of groupware including conferencing, voice over IP VoIP, workflow, document management and other types of collaboration support.

These and other features of the method of the present invention will become apparent from the following drawings and detailed description of the present invention.

GROUPING IV—Local Facility—This grouping if not pre-defined and is included to provide flexibility to meet unique organizational needs.

### BRIEF DESCRIPTION OF THE DRAWINGS

FIG. 1 illustrates the integration of components into a server-less office that satisfies the business objectives and meets the business constraints.

FIG. 2 illustrates the decision-making process of the present invention.

FIG. 3 illustrates an example of a desktop computer architected using the present invention.

FIG. 4 illustrates an example of a server-less office architected according to the present invention;

FIG. 5 illustrates a generic server-less office architected according to the present invention; and

FIG. 6 illustrates the same configuration of the server-less office components as FIG. 5, but substitutes icons for hardware for the generic diagram elements.

It is to be understood that these drawings are solely for purposes of illustrating the concepts of the invention and are not intended as a definition of the limits of the invention. The embodiments shown in the figures herein and described in the accompanying detailed description are to be used as illustrative embodiments and should not be construed as the only manner of practicing the invention. Also, the same reference numerals, possibly supplemented with reference characters where appropriate, have been used to identify similar elements in the various views presented by the Figures.

### DETAILED DESCRIPTION

It is to be understood by persons of ordinary skill in the art that the following descriptions are provided for purposes of illustration and not for limitation. An artisan understands that there are many variations that lie within the spirit of the invention and the scope of the appended claims. Unnecessary detail of known functions and operations may be omitted from the current description so as not to obscure the present invention.

In the following disclosure an example of the framework-guided method of the preferred embodiment is provided as applied to a hypothetical set of business objectives and business constraints. A set of candidate IT components is selected to meet these objectives and satisfy these constraints. Then, a preferred embodiment of the present invention is applied to derive an architecture based on the set of candidate IT components that ‘best’ meets the business objectives and business constraints.

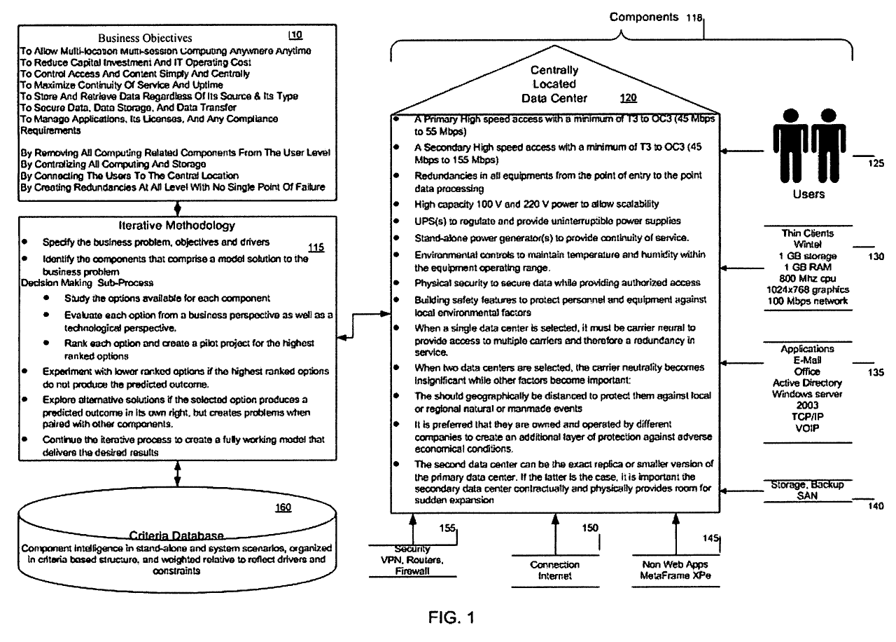

FIG. 1 illustrates the interrelationship between the business objectives and business constraints 110, the iterative method 115, and the resulting sever-less office architecture 118 of the present invention. The business objectives and business constraints at both the global and local levels are translated into selection and performance criteria by the present invention and used to derive a ‘best’ server-less office architecture comprising selected, tested, and integrated IT components that have been selected using a weighted scoring of the satisfaction of the criteria by candidate IT components. The results are stored in a criteria database 160. The architecture of a preferred embodiment always includes a centrally located data center 120, remote and local users 125, thin client workstations with appropriate configurations 130, business relevant applications 135, storage and backup capability 140, access to applications that are not web-enabled 145, connection to the Internet 150, and security functions and capabilities 155. The present invention prejudices the selection of candidate IT components to include these types of architectural components but does not favor any particular candidates.

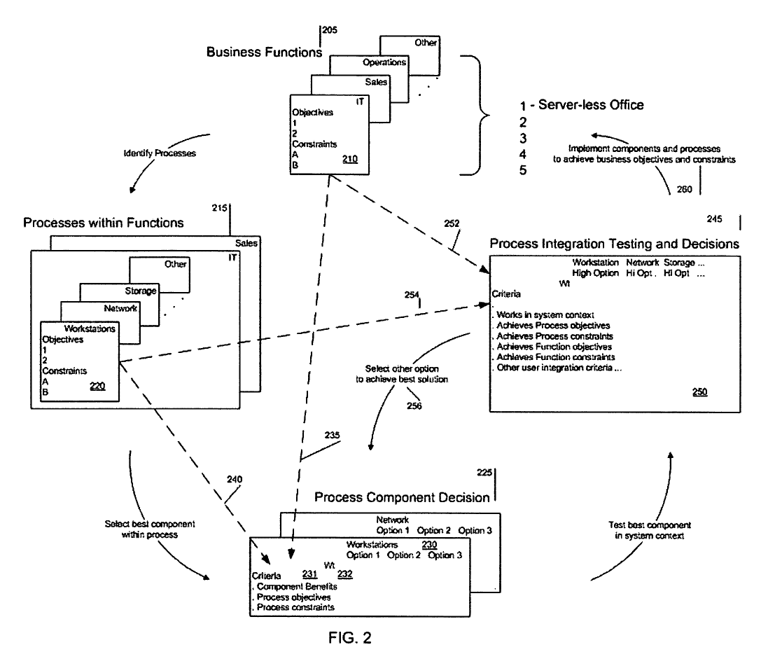

FIG. 2 illustrates a preferred iterative decision making method of the present invention. Business functions 205 are associated with business objectives and business constraints 210.

The processes within the IT business function 215 need to be identified, and the objectives and constraints 220 defined for each. Business objectives represent the state that the business wants to achieve. Business constraints represent the restrictions placed on the processes used to achieve the business objective—in terms of things that must be—or can not be—included in the process.

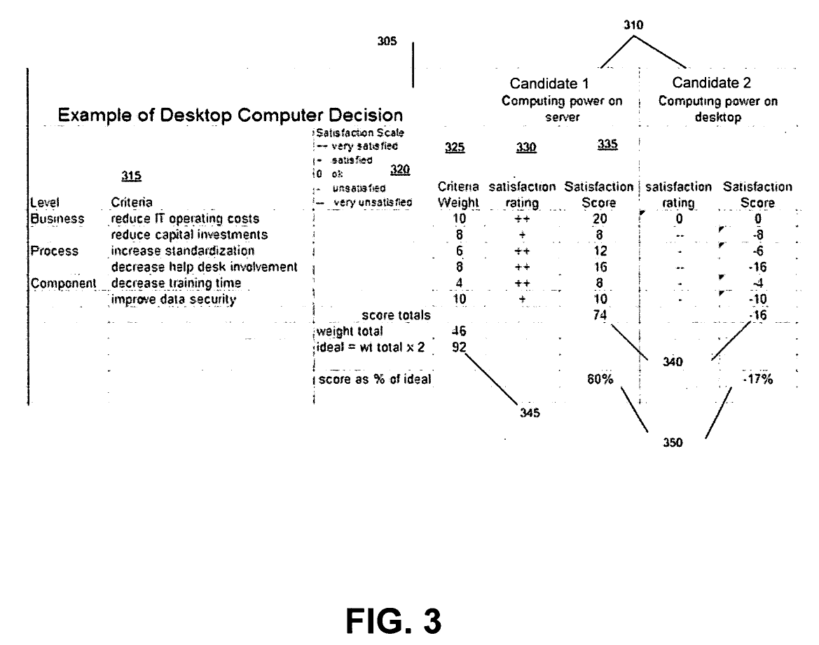

Within a process, the candidate IT components must be evaluated and a best one selected 225. The candidate IT components 230 must be identified, at least one decision criterion must be identified 231, and a relative weight assigned to each criterion 232. The business objectives and business constraints at the function 235 and process 240 levels, along with the candidate IT component's attributes, benefits and interoperability requirements, provide a basis for identifying the at least one decision criterion and assigning the weights within each process. The at least one decision criterion is further defined in terms satisfaction scale which is described in the Summary and illustrated in FIG. 3.

Each candidate IT component is evaluated with respect to the at least one criterion, and rated on the satisfaction scale to indicate how well the candidate IT component satisfies the at least one criterion. The criterion is multiplied by the corresponding weight to obtain a weighted score. A candidate IT component may meet several business objectives and constraints for a given function and one of its component processes. A total process score is obtained for each candidate IT component for all the objective and constraints that it satisfies as well as other items such as benefits and interoperability. The option with the highest score is selected for that process, see, e.g., in FIG. 3)

The present invention anticipates using IDENTICAL off-the-shelf IT components to satisfy all similar business objectives and constraints, e.g., for a database. However, this is not always possible because some requirements are unique and may deserve a particular component, e.g., graphics terminals instead of thin clients. If there is more than one candidate IT component that receives a same satisfaction score, there are three preferred ways to choose a candidate IT component. The first way is to revisit the weights and satisfaction ratings, make any appropriate modifications based on new information, and recalculate the options scores. The second way is to consider both component options during the architecture creating step, evaluate how each performs in the architected server-less office and select the one that performs best. The third way is to include both, based on unique objectives that require each and that were not reflected in the original statement of business objectives and business constraints.

A server-less office architecture comprising the highest rated candidate IT components is then tested 245. The criteria used to rate each candidate IT component are derived from the business functions 252 and the processes 254, as well as interoperability requirements, and focus on how well the component integrates with the other components.

FIG. 3 illustrates architecting a desktop computer 305 that could arise within an IT workstation process. FIG. 3 shows two options 310, one where computing power is placed on the server and the other where computing power is placed on the desktop. The decision criteria 315 selected by the decision makers are drawn from business and process level objectives and constraints, from candidate IT component level attributes and benefits, and from architecture level interoperability requirements.

A subjective 5-point satisfaction scale 320 is created for each ALL criteria. The scale indicates the range of satisfaction for all criteria, and captures the users perspective of what would be very satisfactory (++) for the criteria, satisfactory (+), ok (0), unsatisfactory (−), and very unsatisfactory (−−). In FIG. 3 a satisfaction scale is shown for only one criterion in order to simplify the appearance of the decision making table.

Each criterion is given a weight 325, ranging from high (10) to low (1), that indicates how important the criterion is to the decision-maker relative to the other criterion. When assigning weights, the decision-maker takes into consideration the objectives and constraints from the function and process levels, from the component attributes and benefits, and from the architecture interoperability requirements to determine relative importance.

For each process of each function, each candidate IT component is then rated 330 on the satisfaction scale and a weighted satisfaction score is then computed for the candidate IT component. All the ratings for a candidate IT component are added to obtain a total score 340 for the candidate IT component.

To determine the strength of the total score, it is compared to the ideal score 345 (which is the sum of all the weights times 2—as the ideal score is assigned a very satisfactory rating). In the example, candidate IT component 1 captures 80% of the criteria 350, and is preferable to candidate IT component 2 which has a −16 weighted score 340 and captures a negative 17% of the criteria 350.

In the example in FIG. 3, based on the candidate IT components evaluated and the criteria, weights, and satisfaction scale used, candidate IT component 1 has the highest rating, and achieves more than 50% of the ideal rating, and is the component selected by a preferred embodiment (workstations in the example). Subsequent testing of the workstation architecture may lead to a revision of candidate IT component ratings and a different architecture.

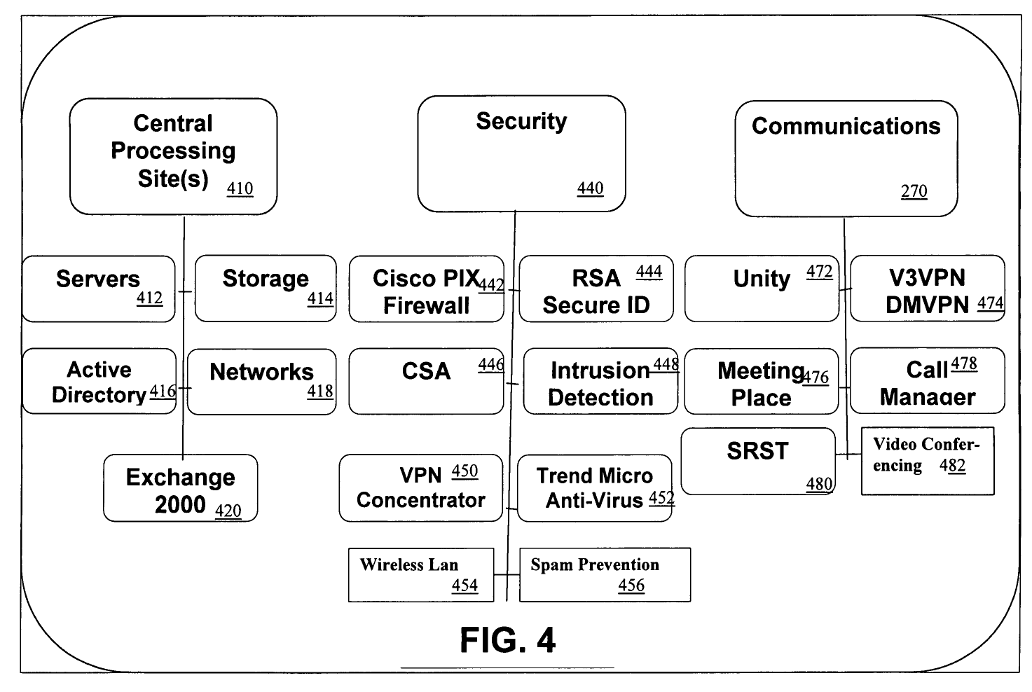

FIG. 4 illustrates an example of a server-less office architected using the method of the present invention. This server-less office combines existing technologies into a unified IT environment.

The present invention anticipates using off-the-shelf IT components. Experience with such components using the present invention to architect a server-less office is included in the sections that follow. Selected candidate IT component are described in the following sections for the server-less office example illustrated in FIG. 4. This example was used to develop the present invention and resulted in the imposition of 3 groups as the organizing paradigm for the server-less office of the present invention. In FIG. 4 the example's server-less office components are organized into these 3 groups.

Group/Grouping I—Central Hosting Facility 410

By taking infrastructure out of existing offices and relocating it to a hosting facility many benefits accrue that would not be cost effective to implement otherwise. These benefits include:
physical security;
power backup for up to 72 hours through generators;
redundant network connections; and
proper ventilation and cooling.

A central hosting facility provides:
a primary high speed access with a minimum of T3 to OC3 (45 Mbps to 55 Mbps);
a secondary high speed access with a minimum of T3 to OC3 (45 Mbps to 155 Mbps);
redundancies in all equipments from the point of entry to the point data processing;
high capacity 100 V and 220 V power to allow scalability;
uninterruptible power supplies UPSs to regulate and provide uninterruptible power supplies;
stand-alone power generators to provide continuity of service;
environmental controls to maintain temperature and humidity within the equipment operating range;
physical security to secure data while providing authorized access; and
building safety features to protect personnel and equipment against local environmental factors.

The choice of the number of central hosting facilities depends on the business objectives, such as:
when a single central hosting facility is selected, it must be carrier-neutral to provide access to multiple carriers and therefore a redundancy in service;
when two central hosting facilities are selected, the carrier-neutral requirement decreases in importance while other factors increase in importance;
preferably, multiple central hosting facilities are geographically distant from one another to protect them against local or regional natural or manmade events;
preferably, the multiple central hosting facilities are owned and operated by different companies to provide protection against adverse economic conditions; and
a second and subsequent central hosting facility can be an exact replica or smaller version of the first or primary central hosting facility. In the latter case, it is important that the second central hosting facility contractually and physically provide for future expansion to become a replica of the primary.
   Typically, a central hosting facility contains all the components of a server-less office architecture in a single location.

In an alternative embodiment, a central hosting facility is a “federated” environment. Federation is an approach to the coordinated sharing and interchange of computerized information emphasizing partial, controlled sharing of data among autonomous hosting facilities each having at least one database. Office information systems provide a particularly appropriate context for this type of information sharing. A federated data sharing architecture is a collection of independent database systems that are united into a loosely coupled federation in order to share information. A federation consists of a plurality of database components and a single federal dictionary that describes each component independent database system. The components represent individual users, applications, workstations, or other components in an office information system. The federal dictionary is a specialized component shared by each independent component database system that maintains the topology of the federation and controls the entry of new components into the federal dictionary. Each component in the federation controls its interactions with other components by means of an export schema and an import schema. The export schema specifies the information that a component will share with other components, while the import schema specifies the non-local information that a component wishes to manipulate. The federated architecture provides mechanisms for sharing data, for sharing transactions (via message types) for combining information from several components, and for coordinating activities among autonomous components (via negotiation).

While a server-less office is typically accessed by a workstation, desktop or laptop that supports a browser over a network (internal user) or the Internet (internal or external user), it can also be accessed by any other device that is capable of supporting the required communication protocols, such as wireless, handheld, and remote access devices.

In a preferred embodiment, an important object is to eliminate computing and, therefore, data and data management, at the user level. Once the processing no longer takes place at the user level, it is possible to provide a lower (and thus cheaper) processing speed to users without impacting their overall productivity.

Active Directory™ 416

The Microsoft Active Directory™ and the Windows® 2000 Server, provide the following capabilities:
framework to accept standardized user names & naming conventions;
single sign-on—one user name & password for users to remember and administrators to manage;
standardized password policies;
increased security via group policy—for secure access to proper resources;
integration with VPN—increased security for wide area & remote access; and
centralized Administration—providing a consistent way of managing an entire network infrastructure thereby maximizing IT efficiency.

The Windows® 2000 Server operating system and the Active Directory™ service integrate applications, users, data, and other resources into a unified environment. Integration between Windows 2000 Server and application services allows companies to build more powerful architectures on the platform by taking advantage of available features without adding layers of complexity, lengthening development time, or increasing management costs.

The Windows 2000 Platform, including Windows 2000 Professional, Windows 2000 Server, Windows 2000 Advanced Server, and Windows 2000 Datacenter Server provide. Although customers can deploy Windows 2000 without deploying Active Directory, many of the advanced features of Windows 2000 are only available if Active Directory™ is deployed.

The features that require or are enhanced by Active Directory™ are briefly outlined below:

Capabilities Requiring Active Directory

Windows 2000 Server provides organizations with a significantly advanced architecture—made possible with Active Directory. The following capabilities can only be achieved by installing Active Directory:
IntelliMirror—IntelliMirror® management technologies use policy-based change and configuration management to enable users' data, software, and settings to follow them throughout a distributed computing environment, whether they are online or offline;
Remote OS Installation Services (RIS)—Administrators can remotely install Windows 2000 Professional on multiple computers, a benefit that eliminates the need to physically visit each client computer;
delegation of administration—Administrators can assign responsibility for managing a portion of the network to another user or group;
objects can be administered granularly, such as the ability to reset passwords;
multimaster replication—any domain controller can accept and replicate changes to any other domain controller;
domains can scale to millions of users; and
Global Catalog (GC)—provides a unified view of all objects in the directory, giving users a powerful and efficient search capability.
   Active Directory™ Sites

Active Directory™ sites let client computers locate and logon to the domain controller that is closest to them.

Kerberos Authentication

Kerberos is the Internet standard security protocol for handling authentication of users or system identity.
Kerberos allows UNIX clients and servers to have Active Directory™ accounts and obtain authentication from a domain controller; and
services can impersonate users allowing middle-tier service to authenticate to a back-end data server on behalf of the user.
   Domain Trusts

A two-way transitive trust is automatically created when a new child domain is created, eliminating the need to manually create and maintain domain trust relationships.
Administrators can create shortcut trusts to shorten the trust path between domains in a complex Active Directory™ forest; and
Administrators can create a trust relationship between a Windows 2000 domain controller and a MIT Kerberos V5 realm.
   Quality of Service (QoS)

QoS Policy is stored in Active Directory, which provides a secure, replicated, and persistent store.
QOS Access Control Settings (ACS) objects published in Active Directory™ are protected by Active Directory™ security settings; and
user authentication is performed using the Internet standard Kerberos protocol.
   File Replication Service (FRS)

System policies and logon scripts stored in the SYSVOL are automatically replicated to all domain controllers. (SYSVOL is an automatically replicated folder used by domain controllers of the same domain.) Multimaster replication allows any domain to propagate changes to any other domain controller.
FRS can copy and maintain shared files and folders on multiple servers simultaneously. When changes occur, content is synchronized immediately within sites and by schedule between sites;
configuration data stored in Active Directory™ and FRS automatically polls Active Directory™ for changes such as add/delete a replica, add/delete a connection, change a schedule and change a file or folder filter; and
secure communications uses authenticated remote procedure call (RPC) with Kerberos encryption.
   Capabilities Enhanced by Active Directory

Although some features in Windows 2000 can be deployed without Active Directory, additional functionality can be enabled through integration with Active Directory:
group policy—group policy is the primary administrative tool for defining and controlling how programs, network resources, and the operating system operate for users and computers in an organization. In an Active Directory™ environment, group policy is applied to users or computers on the basis of their membership in sites, domains, or organizational units (OUs);
universal groups can contain members from any domain in the forest and be used throughout the Active Directory™ forest;
domain local groups can contain members from any domain in the forest, as well as users from trusted domains outside the forest. Domain local groups can be used anywhere within the domain in which they are defined; and
administrators can use nested groups (adding a group as a member of another group), simplifying group management.
   Domain Name System (DNS)

Secure dynamic update enables access control lists (ACLs) that specify the groups or users permitted to modify DNS zones.
Multimaster zone replication allows DNS updates to be written to any Active Directory-integrated DNS server, and the data will be automatically replicated across all domain controllers;
DNS enables a single replication topology for both Active Directory™ and DNS, eliminating manual configuration and maintenance of separate DNS replication topology; and
note: To deploy Active Directory, the Domain Name System (DNS) is required to support the directory namespace.
   Dynamic Host Configuration Protocol (DHCP)

Active Directory™ is used to store records of authorized DHCP servers and neglect rogue servers. Rogue DHCP servers are unauthorized, and if they do not receive confirmation they will not respond to DHCP requests. DHCP allows proxy registration and updates for earlier versions of Windows using secure update.

Routing and Remote Access Service

Remote access policy and remote access permissions can be set for user accounts using Active Directory.

Virtual Private Network (VPN)

VPN is the extension of a private network that encompasses logical links across shared or public networks such as the Internet. VPN support in Windows 2000 is a combination of tunneling technologies, authentication methods, authorization policies, and encryption technologies to secure traffic across a VPN connection. Active Directory™ enhances VPNs in Windows 2000 by allowing authorization to be specified by user or group, including domain-local and universal groups.

IP Security (IPsec)

IPSec Group Policy can be applied to local computers, organizational units, and domains. Because policies store multiple security actions, one policy may be applied to multiple computers; and
a computer's public keys can be published in Active Directory™ for easy retrieval.
   Telephony API (TAPI)
the TAPI H.323 TSP uses Active Directory™ to perform user-to-IP address resolution. The user-to-IP mapping information is stored and refreshed using the Internet Locator Service (ILS) Dynamic Directory, a real-time server component of Active Directory;
TAPI uses Active Directory™ to associate users with particular ILS servers. The Telephony container in the User object contains the name of the ILS server for that user's site, which is then queried for the IP address in question. This eliminates the need to manually configure TAPI programs with the locations of the ILS servers; and
TAPI 3.0 uses the security features of Active Directory™ and the Lightweight Directory Access Protocol (LDAP) to provide for secure conferencing with NetMeeting® software over the Internet. Each Active Directory™ object has an Access Control List (ACL) specifying object-access rights on a user or group basis. By associating ACLs with SDP conference descriptors, conference creators can specify who can enumerate and view conference announcements.
   File Services
disk quotas can be defined based on user identities in Active Directory; and
file shares can be published in Active Directory™ for simplified browsing of network resources.
   Distributed File System (DFS)
DFS allows administrators to organize disjointed and distributed shares into a single hierarchy, a benefit that provides numerous advantages such as letting users easily find the closest printer to their location; and
DFS uses Active Directory™ to automatically redirect requests to the nearest available server.
   Encrypting File System (EFS)

Used in conjunction with Certificate Services, EFS enables auto-enrollment, publication of public keys in Active Directory™ for easy retrieval and publication, and the Certificate Revocation List in Active Directory™ for validating certificates.
group policy-recovery agent provides domain-wide consistency. Computers that are joined to the domain cannot bypass recovery policy;
by storing the users' private key in Active Directory, administrators can enable roaming user profiles, a benefit that gives users access throughout the network to user-specific configuration settings, such as program items, screen colors, network connections, printer connections, mouse settings, and window size and position; and
administrators can store EFS files on network file shares.
   Security Groups
universal groups can contain members from any domain in the forest and be used throughout the Active Directory™ forest;
domain local groups can contain members from any domain in the forest, as well as users from trusted domains outside the forest. Domain local groups can be used anywhere within the domain in which they are defined; and
administrators can use nested groups to add a group as a member of another group, simplifying group management.
   Print Services
printers can be automatically published in Active Directory;
users can search for printers by an attribute such as a color printer; and
with Group Policy, administrators can control adding/deleting printers as well as access to Internet printing.
   Internet Information Services (IIS)
IIS supports advanced authentication methods including basic, digest, integrated windows, certificates, and FTP basic;
IIS enables directory service mapping of user certificates to Active Directory™ user accounts; and
IIS provides the ability to control Web resource access using Active Directory™ security groups.
   Smart Cards

Smart cards are a tamper-resistant and portable way to provide security capabilities for tasks such as client authentication, logging on to a Windows 2000 domain, code signing and securing e-mail. In an environment, smart card users have a single sign-on to the domain.

Terminal Services

A Terminal Services profile can be created for each user in Active Directory. Administrators can then create user profiles tailored to the Terminal Services environment. The Terminal Services profile can be used to restrict access to applications by removing them from the user's Start menu. Administrators can also create and store network connections to printers and other resources for use during user sessions.

Servers 412

An organization can require separate servers to address unique purposes by a business objective that recites this requirement. Some examples of dedicated servers include:

Microsoft Certificate Server

With Microsoft Certificate Server and Active Directory, administrators can:
auto enroll computers to receive machine certificates that can be used for remote access authentication;
automatically issue or deny certificate requests based upon policy and security permission set for the certificate type requested;
issue certificates that can be used with smart cards for Windows 2000 domain logon;
publish user certificates in Active Directory™ for easy retrieval by public key enabled applications;
publish certificate revocation lists in Active Directory™ that are used to determine if a certificate is still valid; and
use certificate templates to enforce credential checks on users during certificate enrollment, automatically generate certificate subject name, and add a predefined list of certificate extensions to the issued certificate, which reduces the amount of information a requestor has to provide.
   Services for NetWare

Microsoft Directory Synchronization Server synchronizes information from NetWare bindery or NDS to Active Directory.

Search Assistant

This enables attribute-based searching for printers and people in the directory.

Message Queuing Services

Configuration and status information is stored in Active Directory.

Exchange 2000

Microsoft Exchange 2000 Server™ relies heavily on Windows 2000 in three main areas: the directory, transport and name resolution. For additional information on integrating Microsoft Exchange 2000 and Windows 2000 see the Microsoft Exchange Server Web site.

Networks 418

Organizations can specify business objectives for their branch offices and other remote sites to be able to make private connections to hosting centers.

VPN technology allows companies to connect branch offices or other sites over a public network (such as the Internet), while maintaining secure communications.

Storage via a Storage Area Network 414

Greater Application Availability—Because SAN storage is externalized; it can be easily accessed through alternate data paths, (clusters) eliminating single points of failure

Better Application Performance—the performance of server-attached storage is limited by the CPU speed and activity of the server. Being freed from a directly attached server, SAN storage is not impacted by its host. Like conventional subnets, SANs add bandwidth without placing more overhead on the primary LAN

Storage Area Network (SAN)

Practical Data Movement—SANS enable implementations of high-availability, disaster protection configurations, remote clusters, mirroring and vaulting;
Centralized Storage—By providing the means to consolidate storage, SANs deliver greater scalability, reliability and flexibility; and
Fault Tolerance—Redundant drive enclosure power supplies, blowers, controllers, cache battery backup, distributed hot spare disks and a multi-level V-RAID architecture ensures fault tolerance against system outages and data loss.
   Exchange 2000
integrated into Active Directory, (AD) providing a single management point for messaging system;
Instant Messaging, (IM), offering secure IM services within a company or business to business;
conferencing & collaborating, providing ability to share applications & files, conduct discussions, and exchange white board diagrams; and
customized control via relay server. All inbound mail scanned before message reaches the Information Store, (IS—the Exchange “DataBase”).

The present invention provides this functionality or interfaces with a typical third party component, such as the Microsoft Exchange 2000 Server™, which offers capabilities such as the following:

Exchange 2000 Server™ 420

Exchange 2000 Server™ provides a wide array of features and functionality. Highlights include:
messaging and collaboration;
integrated with the Windows 2000 Active Directory™ for lower cost of ownership;
single-seat administration with MMC;
unlimited database size for maximum scalability;
multiple message databases for fast restores and flexible data management;
two-way Active/Active clustering (requires Windows 2000 Advanced Server);
distributed services for hosting millions of users;
policies for changing a wide range of objects (like mailboxes) quickly;
fault-tolerant SMTP routing for reliable and fast message delivery;
use of Windows 2000 ACLs makes secure e-mail and collaboration easy; and
native MIME content storage increases Internet mail performance.
   Collaboration and Applications
easy access to information from a wide range of client software, including Windows File Explorer;
save and read directly from Microsoft Office using standard dialog boxes;
manage documents and e-mail in the same folder and with the same tools;
store properties with documents for easy information management;
built-in content indexing and search for fast location of documents;
browser access to all Web Storage System content with user-friendly URLs;
build high-performance applications with Collaboration Data Objects;
built-in support for internet standards such as HTTP and XML;
support for OLE DB and ADO for standard access to information;
secure, integrated workflow engine and visual design tool;
FrontPage 2000 integration makes building Web applications easy;
reusable Web components and data forms for rapid application design; and
synchronous and asynchronous events for custom applications.
   Anytime, Anywhere Communication
enhanced Outlook Web Access for access to information from anywhere;
Instant Messaging for easy, spontaneous communication;
presence information for maintaining a “buddy list”;
enhanced chat services for better collaboration;
unified messaging platform for combining voice and data;
voice Profile for Internet Mail (VPIM) for voice mail system interoperability;
enhanced chat services featuring increased scalability and control;
data, audio, and video conferencing (requires Exchange 2000 Conferencing Server);
conference management that limits bandwidth consumption (requires Exchange 2000 Conferencing Server); and
Active Directory™ integration for conferencing (requires Exchange Conferencing Server).
   Group/Grouping II—Security Facility 440
   Cisco Security Agent (CSA) 446

The Cisco Security Agent offers capabilities such as the following:

Cisco Security Agent provides threat protection for server and desktop computing systems, also known as endpoints. It identifies and prevents malicious behavior, thereby eliminating known and unknown (“Day Zero”) security risks and helping to reduce operational costs. The Cisco Security Agent aggregates and extends multiple endpoint security functions by providing host intrusion prevention, distributed firewall capabilities, malicious mobile code protection, operating system integrity assurance, and audit log consolidation, all within a single product. And because Cisco Security Agent analyzes behavior rather than relying on signature matching, it provides robust protection with reduced operational costs.

Virus Protection 452

Trend Micro, offers capabilities such as the following: InterScanr™ Messaging Security Suite

Trend Micro™ InterScanr™ Messaging Security Suite is an extensible, policy-based messaging security platform for the gateway that addresses mixed-threat attacks by delivering coordinated policies for antivirus, anti-spam, and content filtering. InterScanr™ Messaging Security Suite helps IT managers minimize time-consuming installation and configuration for multiple messaging security systems. Its extensible platform approach to messaging security reduces total cost of ownership and provides enhanced protection from the multiple, aggressive tactics employed by mixed-threat attacks to infiltrate network defenses. When deployed with Trend Micro™ Control Manager™, InterScanr™ Messaging Security Suite provides enterprise-wide visibility of the messaging security platform, allowing centralized reporting and configuration, pattern file and scan engine updates, and management of Trend Micro™ Outbreak Prevention Services—all accessible via remote administration

Spam Prevention (456)

Trend Micro™ Spam Prevention is a high-performance anti-spam application designed to protect the enterprise from spam at the gateway. It is integrated with the award-winning Trend Micro™ InterScanr™ Messaging Security Suite, which provides comprehensive messaging security—antivirus, content filtering, and anti-spam—in one easy-to-manage platform. Spam Prevention is designed to defeat spam using patent-pending heuristics rules technology—a technology that offers more adaptable and “future-proof” protection against the ever-changing tactics of spammers. Policy-based configuration options allow administrators to assign variable catch rate sensitivities based on spam category and user groups, along with flexible Filter Actions for appropriate message disposition options. Spam Prevention can delete, quarantine, tag and more based on spam likelihood level. When implemented using the End User Quarantine (EUQ) feature, Spam Prevention can also route suspicious “graymail” messages to mail server-side folders for end user review and create “approved sender” lists both at the gateway and the mail server, to help administrators improve the accuracy and effectiveness of spam filtering over time and to provide more customized filtering for each user.

ScanMail for Microsoft Exchange

ScanMail™ for Microsoft™ Exchange provides real-time detection and removal of viruses from email and attachments, before they reach the desktop. It is easy to deploy and configure via either a Web or Windows-based management console. Coupled with the ScanMail™ eManager™ plug-in, it provides comprehensive content filtering to help block non-business email and filter inappropriate content in emails and attachments. ScanMail™ is fully integrated with the latest Microsoft APIs and supports Microsoft Exchange 5.5, Microsoft Exchange 2000, and NOW Exchange 2003 servers. ServerProtect for Microsoft Windows/Novell NetWare ServerProtect™ provides comprehensive antivirus scanning for servers, detecting and removing viruses from files and compressed files in real time—before they reach the end user. Administrators can use a Windows-based console for centralized management of virus outbreaks, virus scanning, virus pattern file updates, notifications, and remote installation. ServerProtect™ supports Microsoft™ Windows™ Server 2003, Microsoft Windows 2000, Microsoft Windows NT™ 4, and Novell™ NetWare™ servers.

OfficeScan Corporate Edition

Trend Micro™ OfficeScan™ Corporate Edition is an integrated client/server security system designed to protect against the daily threats of file-based and network viruses as well as secure access from intruders, Spyware, and other threats. Security policy is enforced with Cisco network access devices that support Network Admissions Control (NAC), or through Network VirusWall. Its powerful Web-based management console gives administrators transparent access to every desktop and mobile client on the network for coordinated, automatic deployment of security policies and software updates.

RSA Security ID 444

A secure, simple way to lock down a Windows® environment.

By replacing vulnerable passwords with the industry's leading two-factor authentication, RSA Security and Microsoft® will make it possible for customers to positively identify users before granting them access to valuable corporate resources accessed through Windows® desktops and networks—while simultaneously delivering a simplified and consistent user login experience.

The RSA SecurID® for Microsoft® Windows® Is Designed To Provide:

Secure Access to Windows® Networks and Desktops

RSA SecurID for Microsoft® Windows® software helps to provide greater security than weak, static passwords. By combining something the user knows (i.e., a secret PIN) with something the user possesses (i.e., a unique RSA SecurID token that generates a one-time password every 60 seconds), Microsoft® Windows® customers gain an effective way to secure user access to valuable company resources.

A Simple, Consistent User Login Experience—Both On- and Offline

Today's user is generally required to remember different passwords, which vary depending on how and from where the user is logging on to the Microsoft® network. The RSA SecurID for Microsoft® Windows® is engineered to provide a single, consistent user login experience, regardless of whether the user is working on- or offline, remotely or inside the walls of the enterprise.

Increased Compliance with Industry and Government Regulations

As public companies struggle to find effective, manageable procedures for complying with industry and government regulations, RSA SecurID for Microsoft® Windows® software helps to provide the global auditing capabilities that can help companies meet these challenging requirements and avoid the hefty fines and potential legal costs that can result from non-compliance.

Cisco PIX Firewall 442

The Cisco PIX Firewall offers capabilities such as the following:

The Cisco PIX Security Appliance plays a vital role in the Cisco strategy to use integrated security to build a Self-Defending Network.

From compact “plug-and-play” appliances for small and home offices to modular carrier-class gigabit appliances for enterprise and service-provider environments, Cisco PIX Security Appliances provide robust, enterprise-class integrated network security services to create a strong multilayered defense for fast-changing network environments.

Security and networking services include virtual LAN (802.1q tag) support; Open Shortest Path First dynamic routing; Network Address Translation; Port Address Translation; content filtering (Java/ActiveX); URL filtering; authentication, authorization, and accounting (RADIUS/TACACS+) integration; support for leading X.509 public key infrastructure systems; and Dynamic Host Configuration Protocol client, server, relay, and Point-to-Point Protocol over Ethernet support.

Cisco PIX Security Appliances support various remote access VPN clients including Cisco software VPN clients (available on many platforms including Microsoft Windows, Linux, Solaris, and Mac OS X), Cisco hardware VPN clients (such as the Cisco PIX 501 and PIX 506E security appliances, VPN 3002 hardware client, and Cisco 800 or 1700 series routers), as well as Point-to-Point Tunneling Protocol and Layer 2 Tunneling Protocol clients in Microsoft Windows operating systems. Cisco PIX Security Appliances encrypt data using 56-bit Data Encryption Standard (DES), 168-bit Triple DES (3DES), or up to 256-bit Advanced Encryption Standard (AES) encryption. Many Cisco PIX Security Appliance models support modular upgrades and have integrated hardware VPN acceleration capabilities, delivering highly scalable, high-performance VPN services.

Cisco PIX Security Appliances also provide advanced security services for multimedia and voice standards, including H.323 Version 4, Session Initiation Protocol, Cisco Skinny Client Control Protocol, Real Time Streaming Protocol, and Media Gateway Control Protocol, allowing businesses to securely take advantage of the many benefits that converged data, voice, and video networks deliver.

VPN Concentrators 450

The Cisco VPN Concentrators offers capabilities such as the following:

The Cisco VPN 3000 Series Concentrators are purpose-built, remote access virtual private network (VPN) platforms that incorporate high availability, high performance, and scalability with the most advanced encryption and authentication techniques available today. Supported connectivity mechanisms include IP security (IPSec), Point-to-Point Tunneling Protocol (PPTP), Layer 2 Tunneling Protocol (L2TP) over IPSec, and Cisco WebVPN (clientless secure sockets layer [SSL] browser-based connectivity).

With the VPN 3000 Series, organizations can take advantage of the latest VPN technology to reduce communications costs. Unique to the industry, this scalable platform offers field-swappable and customer-upgradeable components. These components, called Scalable Encryption Processing (SEP) modules, enable users to easily add capacity and throughput.

The Cisco VPN Client software is provided with all versions of the Cisco VPN 3000 Series, and it includes unlimited distribution licensing. WebVPN is also provided with no additional licensing fees and enables access to critical enterprise applications including Web pages, file shares, e-mail, and Transmission Control Protocol (TCP)-based applications such as Telnet and Secure Shell Protocol (SSH). Granular access control and logging is available for WebVPN users.

The Cisco VPN 3000 Series Concentrator is available in both non-redundant and redundant configurations, allowing customers to build the most robust, reliable, and cost-effective networks possible.

Wireless LAN (454)

The Cisco Wireless LAN offers capabilities such as the following:

The CiscoWorks WLSE is a centralized, systems-level architecture for managing the entire Cisco Aironet wireless LAN (WLAN) infrastructure. The advanced radio frequency (RF) and device management features of the CiscoWorks WLSE simplify the everyday operation of WLANs, ensure smooth deployment, enhance security, and maximize network availability, while reducing deployment and operating expense. The CiscoWorks WLSE enables administrators to detect, locate, and mitigate rogue access points and RF interference. The assisted site survey feature automates the previously manual, expensive, and time consuming process of determining optimal access point settings including transmit power and channel selection. The CiscoWorks WLSE automatically configures access points and bridges, assures the consistent application of security policies, and proactively monitors faults and performance. The CiscoWorks WLSE is a core component of the Cisco Structured Wireless-Aware Network.

Benefits, which add to the weight of this IT component include

reduces deployment and operating expense;
simplifies daily operation and management of medium and large scale wireless LANs;
enhances security by detecting, locating and mitigating rogue access points, by ensuring consistent application of security policies, and by monitoring 802.1X performance;
improves WLAN performance and availability by detecting RF interference and by monitoring faults; and
saves time and resources by automating and centralizing repetitive, time-consuming management tasks.
   Intrusion Detection 448

The Cisco Network Intrusion Detection offers capabilities such as the following:

The Cisco Intrusion Detection System (IDS) 4200 Sensors are members of the market-leading Cisco IDS Series of products that provide Pervasive Protection throughout the network. They are purpose-built, high-performance network security “appliances” that protect against unauthorized, malicious activity traversing the network, such as attacks by hackers. Cisco IDS sensors analyze traffic in real time, enabling users to quickly respond to security breaches.

The Cisco Countermeasures Research Team (C-CRT) uses a combination of highly innovative and sophisticated detection techniques, including stateful pattern recognition, protocol parsing, heuristic detection, and anomaly detection that provide comprehensive protection from a variety of both known and unknown cyber threats. Furthermore, the Cisco T.A.M.E (Threat Analysis Micro-Engine) technology allows granular customization of sensor signatures, resulting in precisely tuned sensors that minimize the occurrence of “false positives.

When unauthorized activity is detected, the sensor can send alarms to the management console(s) with details of the activity. Additionally, the Cisco IDS Active Response System delivers unparalleled protection by controlling other systems, such as routers, firewalls, and switches, to terminate unauthorized sessions. The installation and management of these turnkey appliances is easy using a wide array of management systems, including a Web user interface, a command-line interface (CLI), or Cisco's highly scalable CiscoWorks VPN/Security Management systems (VMS).

The Cisco IDS 4200 Series of appliance sensors includes four products: the Cisco IDS 4215, IDS 4235, IDS 4250 and the IDS 4250-XL. The entire Cisco IDS appliance portfolio delivers a broad range of systems that allow easy integration into many different environments, including enterprise and service provider environments. Each appliance sensor addresses the bandwidth requirements at one of a variety of performance marks, from 80 Mbps to gigabit. Additionally, a variety of interface options are supported, including the provision of multiple sniffing interfaces and copper/fiber interface options.

Cisco IDS Sensor Software for Cisco IDS Sensors delivers the latest in innovative intrusion detection system (IDS) features, including Active Update signature distribution mechanisms, customizable signature language, extensions to the Active Response capabilities, and secure administration.

Cisco IDS Sensor Software for Cisco IDS Sensors is a component of the industry-leading Cisco Intrusion Detection System, which provides customers with unmatched intrusion protection technology through the Cisco Active Defense System. The integrated hardware and software delivers best-of-breed protection for both perimeter and internal resources.

The CiscoWorks Management Center for IDS Sensors is management software for the configuration of network IDS, switch IDS sensors and IDS network modules for routers. This tool is a featured component of the VPN/Security Management system (VMS). The software allows you manage multiple sensors concurrently by creating sensor groups and thereby saving time for the administrator. The software also provides an easy to use Web interface and wizards to reduce the learning time. The Management Center for IDS Sensors also delivers the capability to create new signatures so that administrators can more accurately detect threats, and the capability to edit signatures to reduce false positives.

Group/Grouping III Communication Facility 470

V3VPN—Voice and Video enable VPN 474

The Cisco V3PN product offers capabilities such as the following.

Voice and video enabled VPN (V3PN) systems integrate cost-effective, secure connectivity provided by site-to-site IPSec VPN's with the AVVID architecture for delivering converged voice, video, and data IP networks. Integrating these two network systems delivers cost-effective, flexible wide-area connectivity, while providing a network infrastructure that enables the latest converged network applications like IP Telephony and Video.

Delivering Toll-Quality Multiservice IPSec VPNs

Virtual Private Networks (VPNs) offer a lower cost and highly flexible alternative to replace or augment dedicated private networks using leased lines, Frame Relay, or ATM. VPNs provide tremendous cost savings for enterprise data networks by utilizing shared networks secured by encrypted VPN tunnels. The trend toward network convergence, however, places new demands on VPNs. With voice and video-enabled VPNs (V3PN) delivered by Cisco, enterprises can leverage cost-effective VPNs to add voice and video to their data network without compromising quality and reliability.

Cisco V3PN systems integrate cost-effective, secure connectivity provided by site-to-site VPNs with the Cisco AVVID architecture for delivering converged voice, video, and data over IP networks. V3PNs deliver cost-effective, flexible wide-area connectivity, while providing a network infrastructure that supports the latest converged network applications like IP telephony and video. Key benefits, which add to weights for this IT component, and applications of Cisco V3PN systems include:
cost-effective voice, video, and data connectivity in geographically dispersed locations—Customers can use the multiservice capabilities of V3PN to connect de-centralized office environments, such as remote office/home office connectivity, complete with a PBX extension. Furthermore, businesses can deliver video-based training and take advantage of the efficiencies of unified messaging applications in these locations to reduce business operations costs;
VPN infrastructure for today's applications—V3PN provides a VPN infrastructure capable of transporting converged voice, video, and data traffic across a secure IPSec network. Unlike many VPN devices on the market, Cisco VPN platforms accommodate the diverse network topologies and traffic types characteristic of multiservice IPSec VPNs, and thereby ensure the VPN infrastructure does not break multiservice applications deployed now or in the future;
end-to-end network architecture—Cisco provides products for all aspects of multiservice VPNs, from Cisco VPN routers with Cisco IOS® software to Cisco CallManager and IP Phones. Furthermore, Cisco provides an overarching deployment model for these products through the Cisco AVVID architecture for converged networking and the SAFE Blueprint for VPNs. These deployment models ensure a secure, interoperable, reliable network system with end-to-end product support;
securing the entire multiservice network—Cisco network security systems provide more than encryption of multiservice traffic across the VPN; they also ensure interoperation with Cisco PIX Firewalls for perimeter security and Cisco Intrusion Detection System for network attack protection; and
service provider partners-Service providers deliver the bandwidth over which VPNs operate. Through the Cisco Powered Network program, enterprises can select service providers who deliver the low-latency network fabric critical to high quality voice and video across the VPN, or select fully managed V3PN services.
   Call Manager 478

The Cisco Call offers capabilities such as the following:

Cisco IP Communications—a comprehensive system of powerful, enterprise-class systems including IP telephony, unified communications, IP video and audio conferencing, and customer contact—helps organizations realize business gains by improving operational efficiencies, increasing organizational productivity, and enhancing customer satisfaction. Cisco CallManager—an integral component of the Cisco IP Communications system—is the software-based call-processing component of the Cisco enterprise IP telephony system; it is enabled by Cisco AVVID (Architecture for Voice, Video and Integrated Data).

Cisco CallManager software extends enterprise telephony features and capabilities to packet telephony network devices such as IP phones, media processing devices, voice-over-IP (VoIP) gateways, and multimedia applications. Additional data, voice, and video services such as unified messaging, multimedia conferencing, collaborative contact centers, and interactive multimedia response systems interact with the IP telephony system through Cisco CallManager open telephony application programming interfaces (APIs). Cisco CallManager is installed on the Cisco Media Convergence Servers (MCSs) and selected third-party servers. Cisco CallManager software is shipped with a suite of integrated voice applications and utilities, including the Cisco CallManager Attendant Console—a software-only manual attendant console; a software-only ad-hoc conferencing application; the Bulk Administration Tool (BAT); the CDR Analysis and Reporting (CAR) tool; the Real Time Monitoring Tool (RTMT); a simple, low-density Cisco CallManager Auto Attendant (CM-AA); the Tool for Auto-Registered Phones Support (TAPS); and the IP Manager Assistant (IPMA) application. Key Features and Benefits which at to the weight of this IT component:

Cisco CallManager Version 4.0 provides a scalable, distributable, and highly available enterprise IP telephony call-processing system. Multiple Cisco CallManager servers are clustered and managed as a single entity. Clustering multiple call-processing servers on an IP network is a unique capability in the industry and highlights the leading architecture provided by Cisco AVVID. Cisco CallManager clustering yields scalability of from 1 to 30,000 IP phones per cluster, load balancing, and call-processing service redundancy. By interlinking multiple clusters, system capacity can be increased up to 1 million users in a 100+ site system. Clustering aggregates the power of multiple, distributed Cisco CallManagers, enhancing the scalability and accessibility of the servers to phones, gateways, and applications. Triple call-processing server redundancy improves overall system availability.

The benefit of this distributed architecture is improved system availability, load balancing, and scalability. Call admission control (CAC) ensures that voice quality of service (QoS) is maintained across constricted WAN links, and automatically diverts calls to alternate public switched telephone network (PSTN) routes when WAN bandwidth is not available. A Web-browsable interface to the configuration database enables remote device and system configuration. HTML-based online help is available for users and administrators.

The enhancements provided by Version 4.0 offer improved security, interoperability, functionality, supportability, and productivity as well as the new Video Telephony function. CallManager 4.0 has many security features that give CallManager users the ability to verify identity of the devices or servers that they communicate, ensure the integrity of data it is receiving, and provide privacy of communications via encryption. Improvements in the CallManager Q.SIG signaling interface expands the range of functions with which Cisco CallManager can connect to other Q.SIG compatible systems. Enhancements to the CallManager APIs (AXL, JTAPI, TSP) provide customers and third party vendors increased ability to develop improved applications that can be integrated with CallManager and IP Phones. CallManager 4.0 introduces Video Telephony that includes support for SCCP and H.323 video and gives the same administration and user experience for voice and video. Common system administration and call behavior with existing audio phone calls help truly merge voice and video. New CallManager 4.0 features like Multiple calls per lines, call join, direct transfer, immediate divert, and ad-hoc conference list and drop any member improve the usability of the phones.

Unity—Unified Communications 472

Cisco Unity offers capabilities such as the following:

Cisco Unity is a powerful Unified Communications system that provides advanced, convergence-based communication services on a platform that offers the utmost in reliability, scalability, and performance.

Cisco Unity integrates with the desktop applications—such as Microsoft Outlook and Lotus Notes—that you use everyday to improve communications, boost productivity, and enhance customer service capabilities across your organization. With Cisco Unity, you can listen to your e-mail over the telephone, check voice messages from the Internet, and (when integrated with a supported third-party fax server) forward faxes to any local fax machine—increasing organizational productivity while improving customer service and responsiveness.

As an integral part of the Cisco AVVID (Architecture for Voice, Video and Integrated Data) environment, Cisco Unity complements the full range of Cisco IP-based voice systems—including Cisco CallManager, Cisco IP Contact Center, and Cisco Personal Assistant. Cisco Personal Assistant is a new-world telephony application that operates with Cisco Unity and streamlines communications by helping users manage how and where they want to be reached.

Cisco Unity is a powerful Unified Communications system that provides advanced, convergence-based communication services on a platform that offers the utmost in reliability, scalability, and performance.

Cisco Unity integrates with the desktop applications—such as Microsoft Outlook and Lotus Notes—that you use everyday to improve communications, boost productivity, and enhance customer service capabilities across your organization. With Cisco Unity, you can listen to your e-mail over the telephone, check voice messages from the Internet, and (when integrated with a supported third-party fax server) forward faxes to any local fax machine—increasing organizational productivity while improving customer service and responsiveness

Meeting Place—Media Conferencing 476

The Cisco Meeting Place offers capabilities such as the following:

Cisco MeetingPlace provides a fully integrated rich-media conferencing system, including voice and Web conferencing capabilities. Residing “on-network”—behind the firewall on internal voice and data networks—Cisco MeetingPlace offers unmatched security, reliability, scalability, application integration, and cost-efficiency.

Offering significant cost savings over traditional service bureau systems, Cisco MeetingPlace—part of the Cisco IP Communications system—takes advantage of existing corporate IP and circuit-switched public switched telephone network (PSTN) voice and data networks to greatly reduce or eliminate transport tolls and recurring conferencing charges.

As conferencing applications have become ubiquitous on corporate desktops, they have increased the productivity of meetings that involve the participation of remote callers. Cisco® MeetingPlace 8106 systems integrate voice, video, and Web conferencing, and enterprise groupware applications for secure on-network, rich-media conferencing. Cisco MeetingPlace 8106 makes these remote meetings as natural and effective as face-to-face meetings.

Enterprise-Class Conferencing

Cisco MeetingPlace offers companies a robust voice- and Web-conferencing platform that they can integrate with their private networks. With carrier-grade hardware and advanced system software, Cisco MeetingPlace 8106 delivers the scalability, reliability, simplified administration, security, and cost-effectiveness that IT organizations require.

The Cisco MeetingPlace 8106 architecture provides for additional growth and scalability. Users can support large deployments with a single system, while global and distributed servers connect through Cisco MeetingPlace 8106 networking capabilities. In addition, high reliability and component redundancies help ensure that Cisco MeetingPlace 8106 is consistently available for critical communications. Administration becomes more streamlined with automated system tools, comprehensive reports, and a high degree of configurability.

Cisco MeetingPlace 8106 offers a highly secure conferencing system. With application security and segmented Web conferencing, users can ensure that their meetings remain private. As an on-network deployment, Cisco MeetingPlace 8106 works with—not around—corporate network security policies.

Industry-Leading Innovations

By taking full advantage of familiar desktop interfaces, customers can adopt Cisco MeetingPlace easily and quickly. With Microsoft Outlook and Lotus Notes integrations, users can view Cisco MeetingPlace meetings in their existing calendars, just as they do with their everyday meetings. Users can also use Microsoft NetMeeting, Lotus Sametime, or an intuitive Cisco MeetingPlace Web conferencing application for sharing presentations, applications, or desktop sharing. Cisco MeetingPlace also fits transparently into the corporate infrastructure to support IT initiatives.

Corporate-Wide Deployments

Cisco MeetingPlace has been successfully deployed and used as both an on-premises system and an outsourced service. Large enterprises use Cisco MeetingPlace to share content for training, sales demonstrations, customer support, and everyday business meetings and communications.

Voice Conferencing

in-session meeting features:
announced entry/departure;
roll call;
breakout sessions;
mute;
out-dial;
lock meeting;
screened entry;
reservationless—option for users to hold voice and Web meetings with a personal meeting ID, and without the need for scheduling;
recording: Automatic recording and playback of meeting sessions; and
lecture-style meetings with Q&A: Listen-only meetings with facilitated question and answer sessions.
   Conference User Interface
speaker ID: Identifies who is speaking at any given moment;
participant lists: Lists all participants attending the meeting;
meeting controls: Allows meeting organizer to mute/un-mute, change speaking ability, record, lock, eject, and end meeting;
find participant: Enables meeting organizer to search for users by calling a sequence of main phone, alternate phone, and pager numbers;
meeting message: Users can prerecord messages for other participants to hear before entering the meeting; and
multi-language support: Personal voice prompt options for English, British English, Japanese, and French-Canadian.
   Web Conferencing
application/desktop sharing: Users can share any application or their desktop from Windows (browser or T.120) or UNIX (T.120);
plus features of audio conference meeting console;
recording and playback: Record and play back meeting recording from your desktop via stream or download;
remote control sharing: Organizers can allow any user to take control of any desktop, application, document, or Website;
chat: Text messaging within meetings between meeting participants, which prevents disruptions;
polling: Participants can vote on questions and give feedback during the meeting;
file attachments: Publish any document to the meeting Web page; and
multi-language support: Web conferencing interfaces in English and Japanese.
   Security
encryption: Cisco MeetingPlace supports encrypted Web pages and Web conferencing traffic via HTTPS and SSL protocols;
internet lock-out controls: Users can designate meetings be held entirely within corporate firewall;
attendee authentication: Meeting organizer can require participants to have system profiles in order to attend a meeting;
automated account management: Cisco MeetingPlace integrates with corporate directories automatically removing profiles of employees once they leave the company;
hacker defenses: Automatically blocks out users after multiple failed login attempts and then pages a system administrator; and
in-session meeting controls: Meeting organizer can specify announced entry and departure, require passwords, lock the meeting, and eject unwanted attendees.
   Dedicated server: Each customer receives their own dedicated Cisco MeetingPlace server for hosted services
   System Administration

Configuration: System options to set usage, scheduling, access, and meeting preference parameters.
customization: Customizable voice prompts and database fields;
reports: Standard configuration, usage, and billing reports. Detailed raw data reports to track meeting and participant details;
capacity management: System parameters to optimize port utilization and meeting traffic charts;
system manager agents: Meeting alerts via e-mail to users and system managers;
system status: Remote management and monitoring via Simple Network Management Protocol (SNMP) traps. Alarm out-dials to phone or pager; and
disaster recovery: Automated tape backup and ability to import/export meeting databases.
   Video Conferencing 482

TANDBERG videoconferencing enables users to accomplish more without leaving the office. It's as fast as a phone call and just as easy to connect. It offers all the advantages of a face-to-face meeting, but much easier to arrange. At every level of an organization, TANDBERG videoconferencing is allowing people to connect and share information faster and more efficiently than with any other technology. Meetings are more engaging. Conferences are more valuable. Conversations are more enlightening. Its technology that is so natural you will forget you're not actually there.

The present invention will provides this functionality or interfaces with a typical third party component, such as the Tandberg videoconferencing system, which offers capabilities such as the following:
all calling services of Cisco CallManager 4.0, including hold, transfer, directory, forward etc.;
softkey design that replicates the IP phone experience;
easy administration. Extensions are set-up through CallManager's web administration tools;
interoperability with H.323 systems from TANDBERG or other vendors; and
PBX functions to call to, conference in and forward to H.323 endpoints (H.323 systems cannot initiate these services).

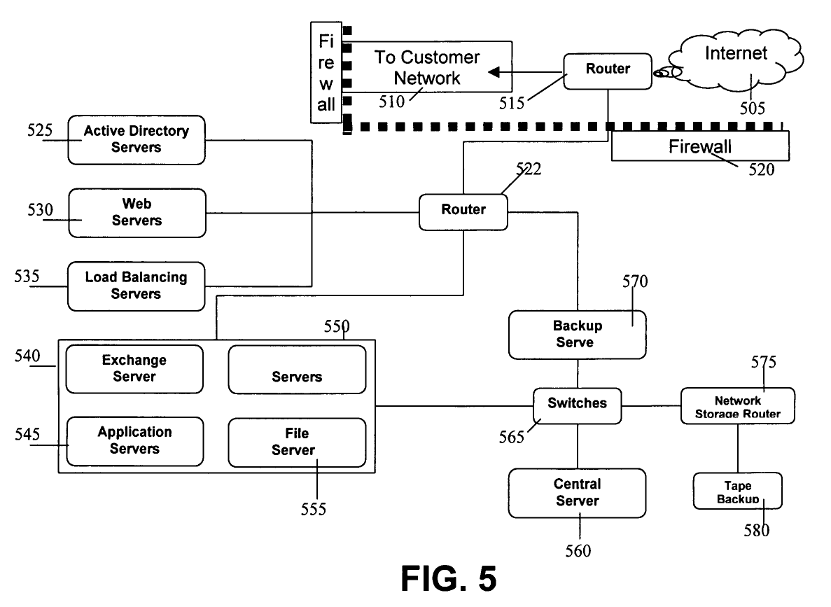

FIG. 5 shows a basic outline of one possible configuration of a server-less office. A user could access the server-less office via the internet 505 or via an internal network 510 where a router 515 would coordinate the access with the firewall 520. A router 522 inside the firewall would direct the communication to the proper component, which could include Active Directory™ services 525, web servers 530, load balancing servers 535, exchange servers 540, application servers 545, database servers 550 or file servers 555. The central server 560 coordinates access to the network storage devices and interacts through switches 565 to coordinate support for real time backup via the backup server 570 through the network storage router 575 to the tape backup devices 580.

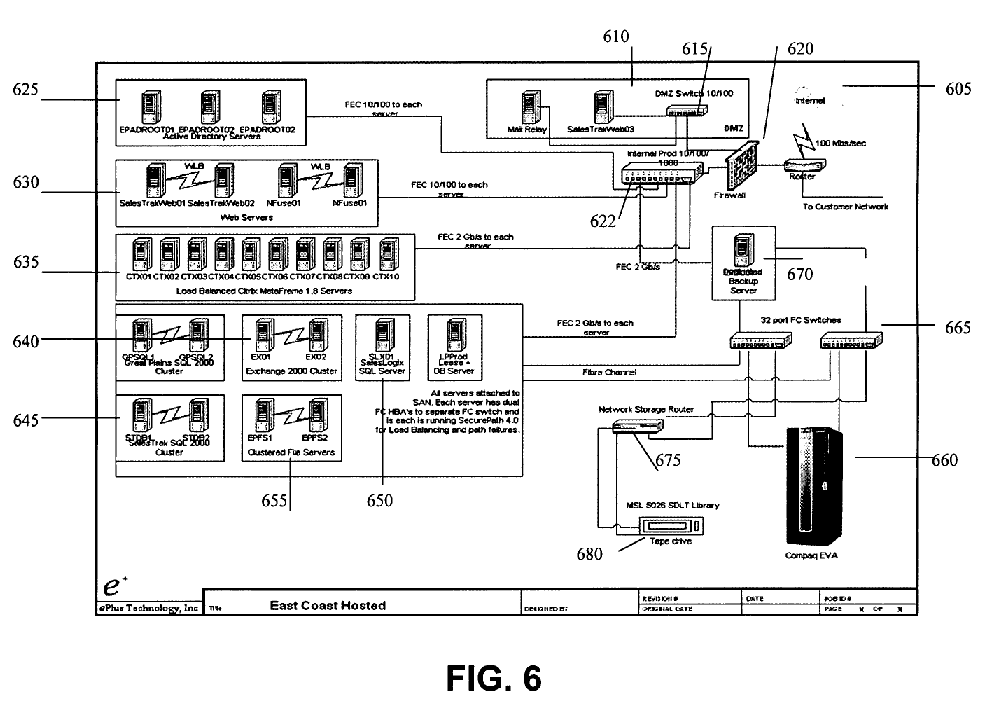

FIG. 6 shows the same basic outline of one possible configuration of a server-less office that is illustrated in FIG. 5, substituting icons of the specified hardware for the generic diagram elements, and using the same element numbering scheme to identify the figure components. A user could access the server-less office via the internet 605 or via an internal network 610 where a router 615 would coordinate the access with the firewall 620. A router 622 inside the firewall would direct the communication to the proper component, which could include Active Directory™ services 625, web servers 630, load balancing servers 635, exchange servers 640, application servers 645, database servers 650 or file servers 655. The central server 660 coordinates access to the network storage devices and interacts through switches 665 to coordinate support for real time backup via the backup server 670 through the network storage router 675 to the tape backup devices 680.

It is anticipated that the method of the present invention will be embodied in systems and interfaced with other systems. For example, a selection criteria may be ‘availability’ of a candidate IT component and satisfaction of the criteria may require going out to a vendor/supplier to determine actual availability in terms of time to deliver. Further, volume discounts may be available for certain items, such as thin clients, and again such satisfaction of cost criteria may require vendor interaction with the method of the present invention. Both of these functions would require the present invention to interface to a sourcing system rather than directly interfacing with a vendor.

While the preferred embodiments of the present invention have been illustrated and described, it will be understood by those skilled in the art, the examples for a server-less office architecture as described herein are illustrative and various changes and modifications may be made and equivalents may be substituted for elements thereof without departing from the true scope of the present invention. In addition, many modifications may be made to adapt the teachings of the present invention to a particular situation without departing from its central scope. Therefore, it is intended that the present invention not be limited to the particular embodiments disclosed as the best mode contemplated for carrying out the present invention, but that the present invention include all embodiments falling with the scope of the appended claims.

1. A method for a server-less office, comprising the steps of:
specifying at least one business function to be accomplished at least in part by a server-less office;
for each specified at least one business function, defining at least one business objective and at least one business constraint that the server-less office must satisfy;
mapping the at least one business objective and business constraint to at least one candidate IT component selection criteria and at least one candidate IT component performance criteria associated with a plurality of candidate IT components of a pre-determined server-less office architecture thereby to create a set of mapped-to criteria comprising mapped-to selection criteria and mapped-to performance criteria;
ranking each of the plurality of candidate IT components in terms of satisfaction of the mapped-to selection criteria; and
validating a server-less office architecture comprising a set of the best ranked candidate IT components that satisfy the mapped-to performance criteria.

2. The method of claim 1, wherein the ranking step further comprises the steps of interfacing with a sourcing system to determine satisfaction of availability and cost criteria.

3. The method of claim 1, wherein the validating step further comprises the step of including in a server-less architecture only a candidate IT component having a combined ranking that exceeds a pre-specified tolerance.

4. The method of claim 1, wherein a tie between candidate IT components is resolved by performing a step selected from the group consisting of reperforming the ranking step with weights applied to the selection criteria to reflect importance of the corresponding criteria, keeping each of the tied candidate IT components in the architecture so that satisfaction of mapped-to performance criteria identifies a best among the tied candidate IT components, and keeping each of the tied candidate IT components in the architecture regardless of how well each the tied candidate IT components satisfies the mapped-to performance criteria.

5. The method of claim 1, further comprising the steps of:
providing a database of pre-selected candidate IT components and associated selection and performance criteria; and
storing the business functions and associated business objectives, business constraints and mappings thereof in the provided database.

6. The method of claim 5, wherein the mapping step further comprises the steps of:
searching the provided database for comparable business functions;
for each comparable business function found, deciding to use or not at least a part of the stored associated business objective, business constraints and mappings thereof in place of or in addition; and
if the decision is to use a found comparable business function, including in the mapping at least a part of the associated business objectives, business constraints and mappings thereof.

7. The method of claim 6, further comprising the steps of:
providing the pre-determined server-less office architecture comprising at least the four groups of central hosting facility, security facility, communication facility, and local facilities and each group including at least one pre-selected candidate IT component; and
associating pre-determined selection and performance criteria with each pre-selected candidate IT component of each of the at least four groups.

8. The method of claim 7, further comprising the steps of:
identifying any attributes and benefits of each of the plurality of candidate IT components; and
wherein the ranking step further comprises the step of adjusting the ranking of a candidate IT component to reflect any identified attributes and benefits.

9. The method of claim 8, wherein the ranking step further comprises the step of weighting the mapped-to selection criteria in terms of importance of the mapped-to selection criteria to the business function corresponding to the mapped-to selection criteria.

10. The method of claim 9, wherein the validating step further comprising the step of adjusting the ranking to reflect how well a candidate IT component satisfies the mapped-to performance criteria for the candidate IT component.

11. The method of claim 10, wherein the validating step further comprises the step of weighting the mapped-to performance criteria in terms of importance of the mapped-to performance criteria to the business function corresponding to the mapped-to performance criteria

12. The method of claim 11, wherein the least one pre-selected candidate IT component of the central hosting facility is selected from the group consisting of Active Directory™, Windows® 2000 Server, Microsoft Certificate Server, Microsoft Directory Synchronization Server, Search Assistant, Message Queuing Services, Exchange 2000, and Storage Area Network.

13. The method of claim 12, wherein the at least one pre-selected candidate IT component of the security facility is selected from the group consisting of Cisco Security Agent, Trend Micro™ InterScanr™ Messaging Security Suite, Trend Micro™ Spam Prevention Solution, ScanMail™ for Microsoft™ Exchange, Trend Micro™ OfficeScan™, ServerProtect™, RSA SecurID®, Cisco PIX firewall, Cisco VPN 3000 Series Concentrators, Cisco Wireless LAN, Cisco Intrusion Detection System 4200, and CiscoWorks VPN/Security Management solutions

14. The method of claim 13, wherein the at least one pre-selected candidate IT component of the communication facility is selected from the group consisting of V3VPN-Voice and Video enable VPN, Call Manager, Cisco Unity, Cisco Meeting Place, and Tandberg videoconferencing.
